(19) United States
(12) Patent Application Publication
(10) Pub. No.: US 2013/0275200 A1
(43) Pub. Date: Oct. 17, 2013

(54) SYSTEM AND METHOD FOR MULTI-TIER AND REAL-TIME PRODUCT LOYALTY INCENTIVE MARKETING

(71) Applicant: Thomas Alkatib, Farmington Hills, MI (US)

(72) Inventor: Thomas Alkatib, Farmington Hills, MI (US)

(21) Appl. No.: 13/627,583

(22) Filed: Sep. 26, 2012

Related U.S. Application Data
(60) Provisional application No. 61/539,449, filed on Sep. 26, 2011.

(51) Int. Cl. G06Q 30/02

(52) U.S. Cl. CPC G06Q 30/0226
USPC 705/14.33

(57) ABSTRACT

The present invention generally relates to multi-tier and real-time product loyalty incentive marketing. Specifically, this invention relates to systems and methods for enabling real-time (or near real-time) product loyalty marketing (e.g., Business to Consumer, Business to Business and Consumer to Consumer) with various marketing channels (such as e-Commerce channel(s), Mobile, Social Network channel(s), Web Site channel(s) and Point of Sales (POS) channel(s)) in one or more multi-tier product loyalty campaigns. All marketing channels are fully integrated via real-time (or near real-time) incentive processing using a backend engine (web services and loyalty data servers) provided by the system.

### CROSS REFERENCE TO RELATED APPLICATIONS

This application claims the benefit of U.S. Provisional Patent Application No. 61/539,449 filed Sep. 26, 2011, the entire disclosure of which is incorporated herein by reference.

### FIELD OF THE INVENTION

The present invention generally relates to multi-tier and real-time product loyalty incentive marketing. Specifically, this invention relates to systems and methods for enabling real-time (or near real-time) product loyalty marketing (e.g., Business to Consumer, Business to Business and Consumer to Consumer) with various marketing channels (such as e-Commerce channel(s), Mobile, Social Network channel(s), Web Site channel(s) and Point of Sales (POS) channel(s)) in one or more multi-tier product loyalty campaigns. All marketing channels are fully integrated via real-time (or near real-time) incentive processing using a backend engine (web services and loyalty data servers) provided by the system.

### BACKGROUND

Customer/product loyalty systems are typically operated by merchants to aid in increasing business and improving customer relationships or increasing brand awareness and utilization. As expected, customer and product loyalty systems (collectively referred to as customer loyalty systems) have improved over the years. An example of a prior art customer loyalty system traditionally enrolls customers into a customer loyalty program and customers earned incentives (e.g., points, discounts, miles) for purchases made using the customer loyalty program. When customers accumulate incentives (e.g., points, discounts, miles) they typically redeemed them for rewards. The disadvantages with this type of loyalty system are that customers may only earn incentives when they themselves made a purchase. To overcome the disadvantages of the previously described loyalty system, a new referral based loyalty system was developed and utilized by a variety of different industries. The referral based loyalty system promised customers the ability to earn additional incentives for referring new customers.

The main focus of the referral based loyalty systems was to award existing customers for enrolling new customers into the loyalty system. The loyalty system customers were still given incentives for purchases as before and were promised an incentive for referring new customers. However, disadvantages still overwhelmed this type of referral based loyalty system.

Customers typically became unmotivated to refer new business and many customers did not want to refer friends and family in return of a very small incentive to be earned. To overcome the disadvantages of the previously described referral based loyalty system, an improved incentive referral based loyalty system was developed and utilized by a variety of different industries.

Improved referral based loyalty system promised customers the ability to earn additional incentives for referring new customers, and promised to provide a bonus incentive to new customers if they were referred by existing customers. The main focus of the improved referral based loyalty system was to award existing customers for enrolling new customers into the loyalty system and to also provide a motivation to the existing customer to refer a friend or relative by enticing them with a generous incentive bonus that the new member would also earn for becoming a member.

Customers were appreciative for earning incentives and rewards for referring new customers to the loyalty system, and were also appreciative that their referral also benefited from becoming a member. In spite these improvements; disadvantages still trouble this type of improved referral based loyalty system, customers were unenthusiastic for only receiving incentives for direct referrals.

Therefore, there is need in the art for a system and method for enabling real-time product loyalty marketing with various marketing channels in one or more multi-tier product loyalty campaigns.

### SUMMARY OF THE INVENTION

Accordingly, it is an aspect of the present invention to provide a system and method for enabling real-time product loyalty marketing with various marketing channels in one or more multi-tier product loyalty campaigns.

According to an embodiment of the present invention, a system for providing real-time product loyalty marketing with various marketing channels in one or more multi-tier product loyalty campaigns includes: an application server comprising a processor, computer-executable code stored in non-volatile memory and a communications means, wherein said processor, said computer-executable code and said communications means are operably connected and are configured to: configure a product loyalty program with multi-tier incentives; receive one or more user registrations associated with said product loyalty program; provide one or more loyalty incentives to at least one user based at least in part on purchases made using said product loyalty program; receive a redemption request from said at least one user; process said redemption request; and distribute a reward to said at least one user based at least in part on said redemption request.

According to an embodiment of the present invention, multi-tier incentives comprise at least one tier of group incentives.

According to an embodiment of the present invention, multi-tier incentives comprise two or more tiers of group incentives with each successive group incentives tier being combinable with the former group incentive tiers.

According to an embodiment of the present invention, multi-tier incentives comprise at least one tier of purchase incentive upgrades.

According to an embodiment of the present invention, multi-tier incentives comprise two or more tiers of product incentive upgrades with each successive product incentive upgrade tier being combinable with the former product incentive upgrade tiers.

According to an embodiment of the present invention, multi-tier incentives comprise at least one tier of referral incentives.

According to an embodiment of the present invention, multi-tier incentives comprise two or more tiers of referral incentives with each successive referral incentive tier being combinable with the former referral incentive tiers.

According to an embodiment of the present invention, multi-tier incentives comprise at least one group incentive tier, at least one product incentive upgrade tier and at least one referral incentive tier.

According to an embodiment of the present invention, the utilization of two or more of said at least one group incentive tier, at least one product incentive upgrade tier and at least one referral incentive tier provides a combination incentive.

According to an embodiment of the present invention, the combination incentive provides an incentive that is independent of any other multi-tier incentive.

According to an embodiment of the present invention, a method for providing real-time product loyalty marketing with various marketing channels in one or more multi-tier product loyalty campaigns includes the steps of: configuring a product loyalty program with multi-tier incentives; receiving one or more user registrations associated with said product loyalty program; providing one or more loyalty incentives to at least one user based at least in part on purchases made using said product loyalty program; receiving a redemption request from said at least one user; processing said redemption request; and distributing a reward to said at least one user based at least in part on said redemption request.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a diagram of a product loyalty system process flow in accordance with an embodiment of the present invention.

FIG. 2 is a diagram of a product loyalty and referral process system, in accordance with an embodiment of the present invention.

FIG. 3 is a diagram of a product loyalty incentives flow diagram for multi-tier rewards, group incentives and purchase incentive level upgrade system, in accordance with an embodiment of the present invention.

FIG. 4 is an architectural diagram illustration an exemplary configuration according to an embodiment of the present invention.

FIG. 5 is an architectural diagram illustrating an alternative exemplary configuration according to an embodiment of the present invention.

FIG. 6 is an architectural diagram illustrating another exemplary configuration according to an embodiment of the present invention.

FIG. 7 is a diagram of a real-time product loyalty incentive management system, in accordance with an embodiment of the present invention.

### DETAILED SPECIFICATION

As used herein, the term “virtual credit” refers to the ability to earn credit through indirect referrals.

As used herein the term “incentive” refers to rewards earned by loyalty system customers, in example, points, credits, bonuses, miles, cash discounts, etc.

As used herein, the term “referral network” refers to all the referrals, both direct referrals and/or indirect referrals, linked or associated to a specific customer.

As used herein, Short Message Service (SMS) is a text messaging service component of phone, web, or mobile communication systems, using standardized communications protocols that allow the exchange of short text messages between fixed line or mobile phone devices. When referring to text messaging herein, one or ordinary skill in the art would appreciate that the term is used in relation to or conjunction with SMS.

As used herein, the terms “Business Command Center” and “Business Command Center Component”, refers to computer implemented solutions for providing a merchant, vendor or other administrator of a system described herein, with functions and methods for administering product loyalty incentive marketing programs.

As used herein, the term “E-Commerce Engine Provider” refers to any provider, whether local or third-party, of e-commerce solutions, such as website shopping carts.

As used herein, the term “Social Networking Site” refers to any electronic social medium for collaborating with one or more users over a network. Examples include Facebook®, Twitter®, LinkedIn® and Google+®.

As used herein, the term “thin client application” refers to a client computer or client software in client-server architecture networks which depends primarily on the central server for processing activities, and mainly focuses on conveying input and output between the user and the remote server.

As used herein, the term “database” refers to a structured collection of records or data that is stored in a computer so that a computer program can consult it to answer queries.

As used herein, the term “database server” refers to a computer program that provides database services to other computer programs or computers, as defined by the client-server model. The term may also refer to a computer dedicated to running such a program.

As used herein, the term “application server” refers to a software engine that delivers applications to client computers or devices. Moreover, an application server handles most, if not all, of the business logic and data access of the application (a.k.a. centralization).

Overview

In general, the present invention describes a multi-level referral based loyalty system and method. According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks), wide area networks (WANs) (e.g., the Internet), mobile networks (e.g., CDMA, GSM) or any combination thereof. In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

According to an embodiment of the present invention, the systems and methods herein described enable real-time product loyalty marketing Business to Consumer (B to C), Business to Business (B to B) and Consumer to Consumer (C to C) with various marketing channels (such as e-Commerce, Mobile, Social Network, Web Site and POS) in a multi-tier product loyalty campaigns. In an exemplary embodiment, all marketing channels are fully integrated via real-time incentive processing using a backend engine (web services and loyalty data servers). Product loyalty means individual or multiple products and business services of any type that are provided by and for individual businesses and consumers via the outlined marketing channels.

Systems for Product Loyalty Primary Real-Time Services:

According to an embodiment of the present invention, the systems herein described may be configured to provide one or more multi-tier product rewards based on consumer to consumer referrals. Each product can have one or many incentive levels that are managed in real-time and made available to all consumers and their referrals through a multi-tier referral incentive tree. Loyalty incentives can be provided in any and all of the following: rewards cash credit, virtual credit, free or discounted promotions, points, discounts, bonus cash, and gift cash or similar others.

According to an embodiment of the present invention, the systems herein described may be further configured to provide sub product multi-tier incentives. In this manner, a company may have unlimited sub-products for each primary product that carry individual incentives that are different that the primary product

Each owner of a product is allowed to manage a unique multi-tier incentive for each consumer. This means each consumer can establish a unique multi-tier incentive referral tree per the offered product by inviting other consumers to link to her or his incentive tree for promoting and purchasing the specific product from any marketing channel.

According to an embodiment of the present invention, the systems herein described may be further configured to provide product to product loyalty marketing. In this embodiment, a cross channel marketing method for pushing incentives based on multi-product loyalty coalition using one or more multi-tier incentive referral trees is utilized.

According to an embodiment of the present invention, the systems herein described may be further configured to provide product promotion management methods. For instance, complete life cycle of real-time product promotions management (such as coupons) that are time and frequency limited may be provided. In an exemplary embodiment, consumer redemption level can be applied and tracked accordingly. Furthermore, real-time promotions may set up via the system utilizing a business command center at any time. Additionally, the system may be configured to provide consumers with special promotion incentives, such as free products or additional discounts if they purchase more products.

According to an embodiment of the present invention, the systems herein described may be further configured to provide one or more group buying discount management components per product. In this manner, each product can be assigned a group buying discount management component configured to provide a special group discount when a minimum limit is reached. In an exemplary embodiment of the present invention, thy system can provide group consumers the ability to purchase products via any of the outlined marketing channels.

According to an embodiment of the present invention, the systems herein described may be further configured to provide a purchase incentive level upgrade management component. The purchase incentive level upgrade management component may be applied to per product or per purchase transactions. In this manner, through the use of a purchase incentive level upgrade management component, the consumer is engaged into additional incentive buying processes. For example, a consumer can gain additional incentives such as 2% cash rewards if they their shopping cart reach $200 in total purchase. In another example, consumer cash rewards level is upgraded by +2% for 12 months and any future purchases if they reach $1,000 in total purchases in one month.

According to an embodiment of the present invention, the systems herein described may be further configured to provide a product loyalty analytics component. The product loyalty analytics component may be configured to provide real-time analysis of product loyalty marketing performance and consumer behavior. In an exemplary embodiment, all of the outlined product loyalty incentive marketing schemes are tracked and analyzed for further performance improvements of product marketing campaigns.

Product Loyalty Delivery Technology

According to an embodiment of the present invention, the systems herein described may be further configured to provide each product with a unique multi-tier incentives for all consumers or specific incentives. Enumerated in the following paragraphs are exemplary incentives in accordance with embodiments of the present invention.

e-Commerce (Shopping Carts, Financial Wallets, Web Sites)

According to an embodiment of the present invention, products are classified by serial numbers or SKU. Incentives are uniquely attached in real-time and referenced when a consumer selects the item via a shopping cart. Consumer incentives are applied automatically in real-time.

Point of Sales Applications

According to an embodiment of the present invention, products are classified by unique serial numbers or SKU. Incentives are uniquely attached in real-time and referenced when a purchase is applied to consumer unique identification and reported in real-time via the consumer sales receipt.

Mobile Commerce

According to an embodiment of the present invention, Consumer to Consumer (C to C) or Business to Consumer (B to C) product marketing may be provided via any mobile application integration. Products are classified by unique serial numbers. Incentives are uniquely attached in real-time and referenced when a consumer selects the item via a shopping cart or a mobile advertisement. Consumer incentives are applied automatically in real-time.

Social Commerce

According to an embodiment of the present invention, Consumer to Consumer (C to C) or Business to Consumer (B to C) product marketing may be provided via any social network application integration. Products are classified by unique serial numbers. Incentives are uniquely attached in real-time and referenced when a consumer selects the item via a social application, social shopping cart or a social advertisement. Consumer incentives are applied automatically in real-time.

Gaming Application

According to an embodiment of the present invention, Consumer to Consumer (C to C) or Business to Consumer (B to C) product marketing may be provided via any gaming application integration. Products are classified by unique serial numbers. Incentives are uniquely attached in real-time and referenced when a consumer selects the item via a gaming application. Consumer incentives are applied automatically in real-time.

Product Loyalty Process Description

According to an embodiment of the present invention, the system may be configured to provide each product a carry unique multi-tier incentives for all consumers or specific incentives to target consumer loyalty and shopping behaviors. Consumer may refer others to buy the specific offered products to gain more incentives when other referred consumers buy them.

According to an embodiment of the present invention, the offered product is pre-set with incentives via a product configuration application using a command center provided by the system. Products may be linked to sub products and services to carry different incentives for consumer to increase their loyalty. Furthermore, products can be linked to other primary products that may be from different manufacturers to create a loyalty coalition to drive cross level marketing campaigns. All loyalty transactions are tracked and managed in real-time via a loyalty technology component provided by the system.

According to an embodiment of the present invention, a particular product incentive may only be available to a customer if the customer first purchases a first product, thereby enabling the product incentive for one or more sub-products associated with the first product. Each associated sub-product may further be associated with a product incentive for further sub-products, allowing for multi-level product incentives across numerous products, product categories and types. In a preferred embodiment, each product incentive associated with a sub-product will only be available to a consumer if the product at the level above the sub-product is first purchased.

According to an embodiment of the present invention, client components are used to engage customers in loyalty marketing and purchase management such as POS, e-Commerce shopping carts, Mobile devices and applications, Social Media applications a news aggregation or business and consumer website integration.

According to an embodiment of the present invention, product loyalty incentives may be scheduled in advance, are time-limited and may carry certain redemption levels and frequency per consumer. Product incentives can also be updated in real-time via some level of administrative tools such as a Command Center application provided by the system.

According to an embodiment of the present invention Product loyalty incentives may also be associated between two or more products automatically via components of the system, such as the command center application. In this manner, products sharing classifications or other characteristics can be linked and incentivized automatically through use of the system. Determination of appropriate product loyalty incentives may also be automated. Automation of the determination of product loyalty incentives may be achieved through characteristics associated with the business, the customer, the products involved, historical product loyalty incentives involving one or more of the products to be incentivized or any combination thereof. One of ordinary skill in the art would appreciate there are numerous characteristics for automating the determination of product loyalty incentives that could be utilized with embodiments of the present invention, and embodiments of the present invention are contemplated for use with any characteristics for determining product loyalty incentives.

Group e-Commerce Process

According to an embodiment of the present invention, the system can be configured to provide a consumer the ability to invite other consumers into special groups for bigger incentives from individual product purchases. The consumer may send invitations and recommendations per product for other consumers to join. The system may be configured to provide the consumer get additional rewards incentives for every referred consumer buying into a product via your referral link Identification.

According to an embodiment of the present invention, the system may be configured to provide methods whereby group purchases may provide an additional deeper discount per product. This discount may be time limited and must meet the minimum group purchase requirement volume before it is made available for everyone.

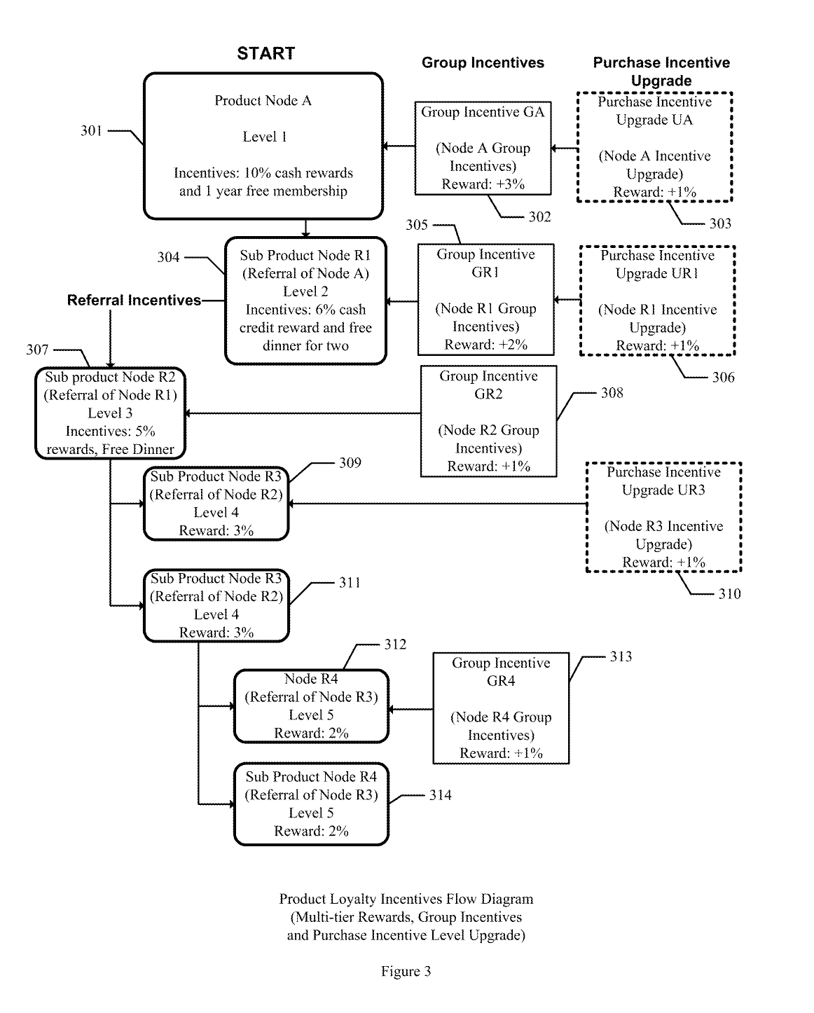

An example of a prior art loyalty system is described in FIG. 3. Usually, a prior art incentive based referral loyalty system is designed to award both the existing customer and the new customer for referring a business to a new consumer. As described in FIG. 3, loyalty system customers are given referral to use to refer family & friends, awarding an incentive for the new customer to join 302 and loyalty system customers are promised an incentive (i.e. points/ discounts) for referring any new customers 304. Then, loyalty system customers refer family & friends into becoming new loyalty system customers 306, referrals enroll into loyalty system and become loyalty system customers 308. Furthermore, referrals are awarded a new customer incentive for joining the loyalty system 310 and also loyalty system customers are awarded incentives (i.e. points/discounts) as agreed for referring new customers 312.

Exemplary Systems and Methods

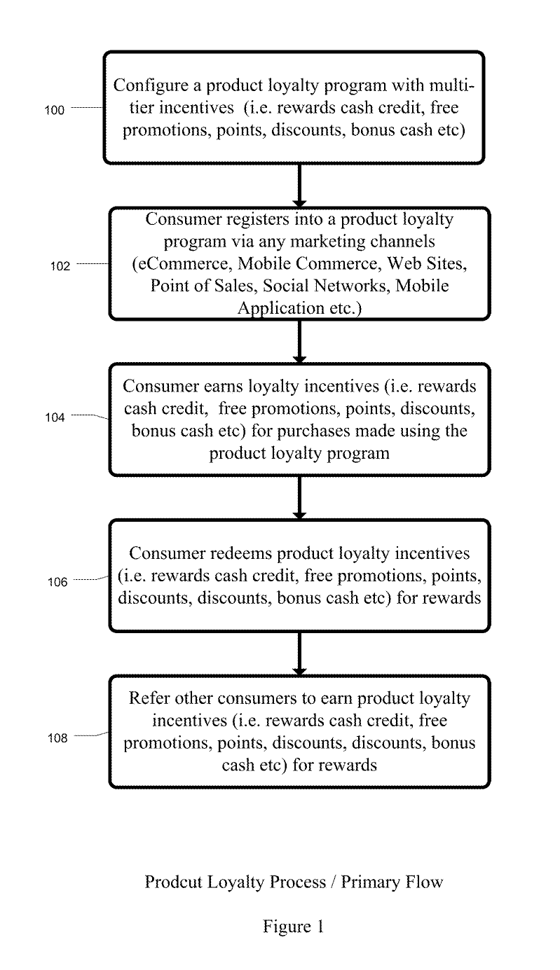

FIG. 1 is a diagram of a product loyalty system process flow in accordance with an embodiment of the present invention.

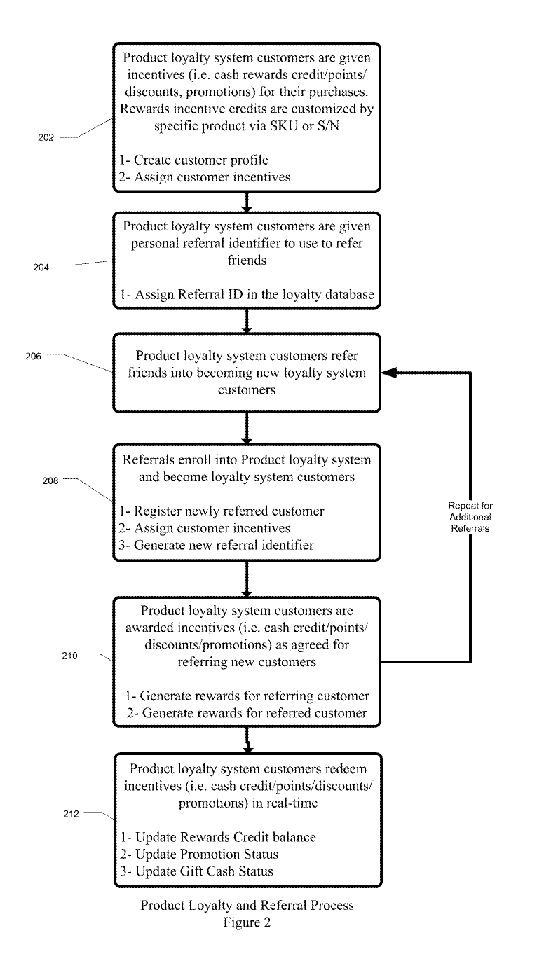

FIG. 2 is a diagram of a product loyalty and referral process system, in accordance with an embodiment of the present invention. The process begins at step 202, when a product loyalty system provides or offers incentives (e.g., cash rewards, credits, points, discounts, promotions) for the purchase of good or services to one or more customers. In an exemplary embodiment, the rewards are customized by specific product(s) via SKUs or serial numbers (S/N).

At step 204, the product loyalty system provides personal referral identifiers to one or more customers to use to refer one or more friends or other individuals. Each of the referral identifiers may be assigned a particular referral ID from the loyalty database. Alternatively, the referral ID may be generated elsewhere and stored in the loyalty database for later reference.

At step 206, the customer refers one or more of their friends or other individuals to join the product loyalty and referral system. At step 208, referrals enroll into the product loyalty and referral system. This step comprises registering the referral, assigning customer incentives to said referral and generating a new referral identifier for the referral.

At step 210, the customer(s) associated with the referral(s) awarded incentives by the product loyalty and referral system. The incentives could be previously determined, random, dynamic or any compatible combination thereof. In an exemplary embodiment, the product loyalty and referral system may generate rewards for both the referring customer and the referred customer, thereby building product loyalty in both the referrer and referee.

Step 212 may occur at any point after a customer has been awarded one or more incentives. Step 212 involves the redemption of one or more accumulated incentives or rewards. This step comprises the actions of conducting a redemption, updating a reward or incentive balance, updating a promotion status and/or updating a gift cash status, or any combination of the preceding steps.

FIG. 3 is a diagram of a product loyalty incentives flow diagram for multi-tier rewards, group incentives and purchase incentive level upgrade system, in accordance with an embodiment of the present invention. At step 301, a product node A for a level 1 incentive is provided. In this present example, a 10% cash reward and 1 year membership is provided. One of ordinary skill in the art would appreciate that the incentive could be any type of incentive. Optionally, one or more level 1 purchase incentive upgrades 303 may be applied to the level 1 incentive and one or more level 1 group incentives 302 may be applied to the level 1 incentive. In an exemplary embodiment of the present invention, these incentive enhancements may be stackable, non-stackable or any combination thereof

At step 304, referral incentives are calculated and applied to level 2 incentives. Similar to above, level 2 purchased incentive upgrades 306 and level 2 group incentives 305 may be applied to the level 2 incentive. Examples include a base level 2 incentive of a 6% cash credit reward and free dinner for two, a +2% level 2 group incentive and a +1% level 2 purchase incentive upgrade.

At step 307, level 3 upgrades may be applied, including level 3 group incentives 308, level 3 purchase incentive upgrades 310 and level 4 sub product node upgrades 309.

At step 311, additional level 4 sub product node upgrades 311 may be applied. This continues to step 312, where level 5 rewards are applied (e.g., group incentives 313, purchase incentives (not shown) and sub product node incentives 312)

At step 314, additional level 5 rewards may be applied. For each step, the rewards may be stackable, non-stackable, proportionally stacked or any combination thereof. In the end, a consumer may benefit from multiple levels of benefits being combined due to their successful referral of other consumers based on one or more levels of referrals.

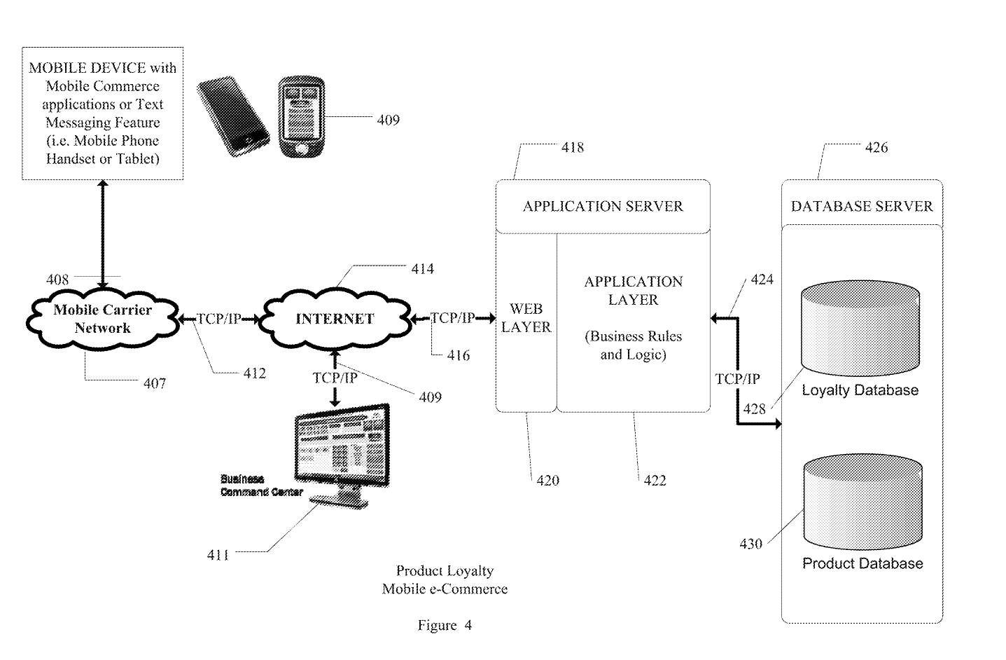

FIG. 4 illustrates an exemplary system, in accordance with the present invention, utilizing a central server architectural provided over one or more mobile carrier networks 407. In this embodiment, a mobile device 409 communicates a transaction by means of a communications method (e.g., CDMA, GSM, Edge. 3g, 4g, 4gLTE, WIFI, SMS) 408. Communications means 408 utilizes one or more mobile carrier networks 407 to communicate with a wide area network (WAN) (e.g., the Internet 414). This conversion can be carried out by way of one or more TCP/IP communication links 412. The internet (i.e., the most identifiable and readily accessible WAN) 414 also communicates the transaction by mean of one or more TCP/IP communication links 416 to the respective application server 418 for processing. The application server 418 comprises the web layer 420 and the application layer 422. The web layer 420 comprises a set of web services and defines business functions. The application layer 422 provides semantic conversion between associated application processes. The application server 418 communicates by means of TCP/IP 424 to the database server 426. The database server 426 comprises loyalty database 428 and product database 430 to process and store transaction data. The database server 426 sends a response by means of TCP/IP link 424 to the application server 418, which in turn sends a response by means of TCP/IP 416 through the internet 414. The response travels through the internet 414 and the response may then travel by the use of 1) TCP/IP 412 to the mobile carrier network 407 to confirm the transactions previously sent to the database server 426 for processing and storage of transaction data; and/or 2) through TCP/IP 405 to a business command center component 411 which may be bi-directionally connected to the system in order to process one or more commands or methods provided by the administrator(s) of the system.

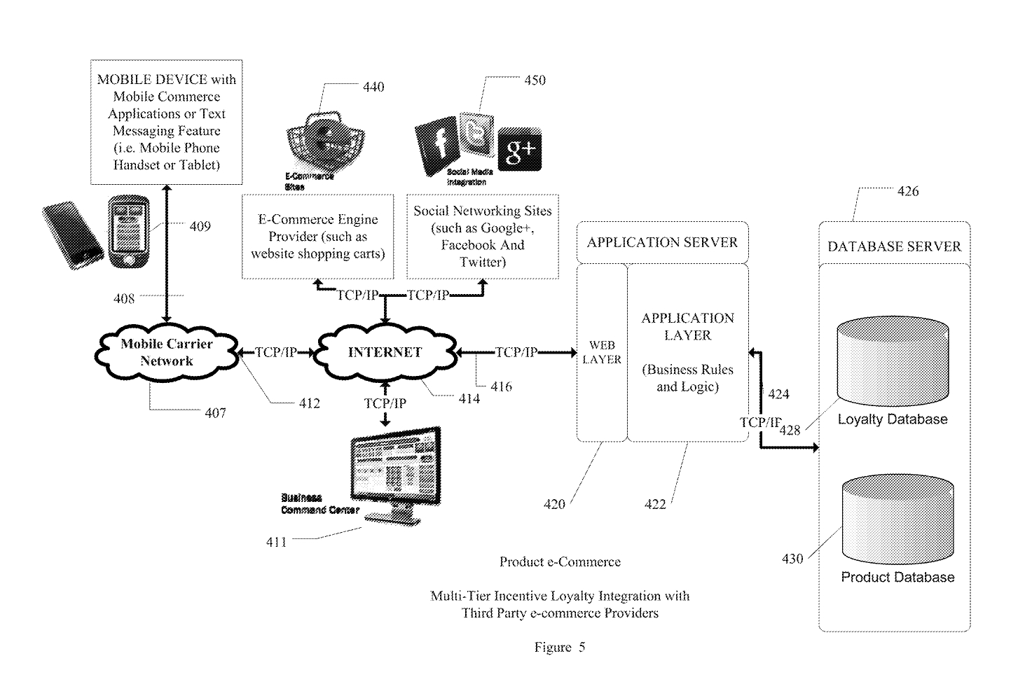

FIG. 5 illustrates an exemplary system, in accordance with the present invention, utilizing a central server architectural provided over one or more mobile carrier networks 407. In this embodiment, a mobile device 409 communicates a transaction by means of a communications method (e.g., CDMA, GSM, Edge. 3g, 4g, 4gLTE, WIFI, SMS) 408. Communications means 408 utilizes one or more mobile carrier networks 407 to communicate with a wide area network (WAN) (e.g., the Internet 414). This conversion can be carried out by way of one or more TCP/IP communication links 412. The internet (i.e., the most identifiable and readily accessible WAN) 414 also communicates the transaction by mean of one or more TCP/IP communication links 416 to the respective application server 418 for processing. The application server 418 comprises the web layer 420 and the application layer 422. The web layer 420 comprises a set of web services and defines business functions. The application layer 422 provides semantic conversion between associated application processes. The application server 418 communicates by means of TCP/IP 424 to the database server 426. The database server 426 comprises loyalty database 428 and product database 430 to process and store transaction data. The database server 426 sends a response by means of TCP/IP link 424 to the application server 418, which in turn sends a response by means of TCP/IP 416 through the internet 414. The response travels through the internet 414 and the response may then travel by the use of 1) TCP/IP 412 to the mobile carrier network 407 to confirm the transactions previously sent to the database server 426 for processing and storage of transaction data; 2) through TCP/IP to a e-commerce engine 440 or a social networking site 450 for the allowance of additional functionality and/or; 3) through TCP/IP 405 to a business command center component 411 which may be bi-directionally connected to the system in order to process one or more commands or methods provided by the administrator(s) of the system.

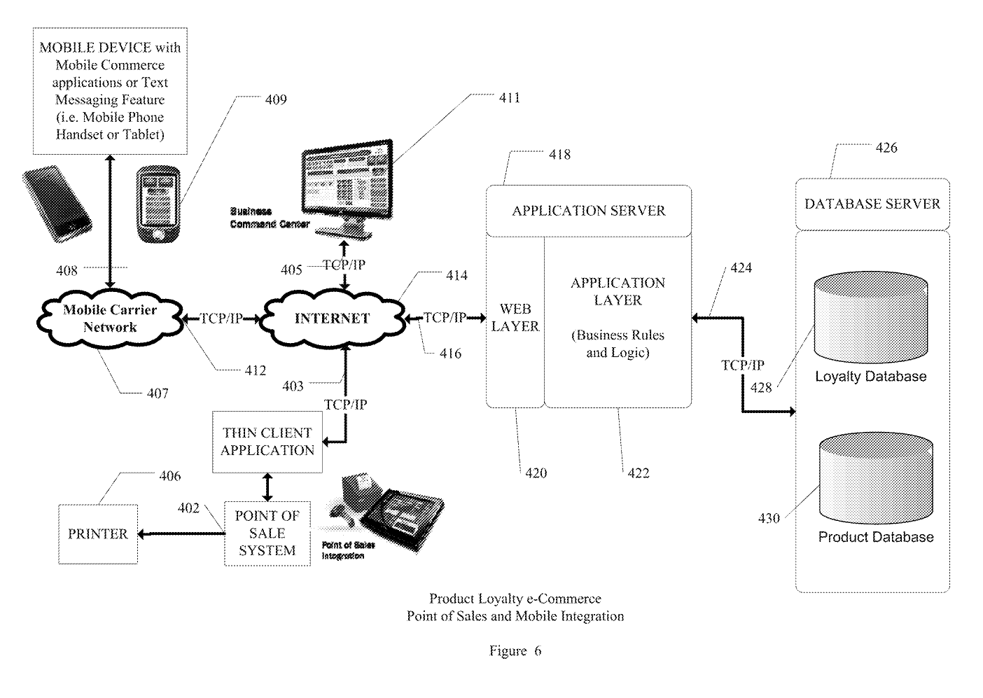

FIG. 6 illustrates an exemplary system, in accordance with the present invention, utilizing a central server architectural provided over one or more mobile carrier networks 407. In this embodiment, a mobile device 409 communicates a transaction by means of a communications method (e.g., CDMA, GSM, Edge. 3g, 4g, 4gLTE, WIFI, SMS) 408. Communications means 408 utilizes one or more mobile carrier networks 407 to communicate with a wide area network (WAN) (e.g., the Internet 414). This conversion can be carried out by way of one or more TCP/IP communication links 412. The internet (i.e., the most identifiable and readily accessible WAN) 414 also communicates the transaction by mean of one or more TCP/IP communication links 416 to the respective application server 418 for processing. The application server 418 comprises the web layer 420 and the application layer 422. The web layer 420 comprises a set of web services and defines business functions. The application layer 422 provides semantic conversion between associated application processes. The application server 418 communicates by means of TCP/IP 424 to the database server 426. The database server 426 comprises loyalty database 428 and product database 430 to process and store transaction data. The database server 426 sends a response by means of TCP/IP link 424 to the application server 418, which in turn sends a response by means of TCP/IP 416 through the internet 414. The response travels through the internet 414 and the response may then travel by the use of 1) TCP/IP 412 to the mobile carrier network 407 to confirm the transactions previously sent to the database server 426 for processing and storage of transaction data; 2) through TCP/IP 403 to a thin client application then to a point of sale system 402 and finally to a printer 406 to confirm the transactions previously sent to the database server and/or; 3) through TCP/IP 405 to a business command center component 411 which may be bi-directionally connected to the system in order to process one or more commands or methods provided by the administrator(s) of the system.

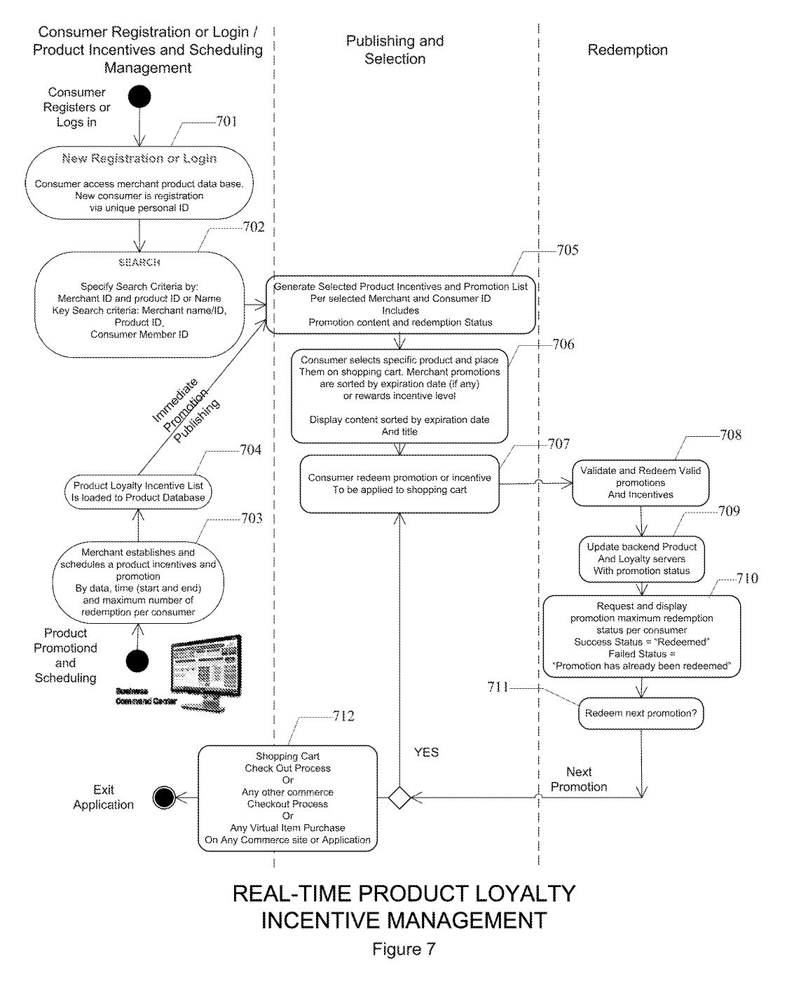

FIG. 7 is a diagram of a real-time product loyalty incentive management system, in accordance with an embodiment of the present invention. The process begins with Consumer Registration or Login 701. After the registration or login of the consumer is processed, the system provides a search facility to the consumer (step 702). The search may be predicated on one or more elements provided by the consumer (e.g., merchant ID, product ID, merchant name, product name, keyword(s), consumer member ID, consumer member name).

At any time prior to, during or after step 702, a merchant may establish and schedule a product inventive and promotion via a business command center component at step 703. At step 704, a list of product incentives and promotions is uploaded to a server. In an exemplary embodiment, this can be done in real-time or near real time.

Returning to consumer's search, at step 705, a list of selected product incentives and promotions is generated and provided to the consumer. In an exemplary embodiment, the list will be comprised of incentives and promotions matching or approximating those for which the consumer is searching.

At step 706, the consumer selects one or more specific products and/or incentives and places them in a purchasing channel (e.g., e-commerce shopping cart). Promotions may be sorted and filtered in numerous manners (e.g., by expiration date, rewards incentive level). The consumer's display may be updated after each sort or filtering is completed.

At step 707, the consumer redeems promotions and/or incentives. These are applied to one or more items contained in the purchasing channel (e.g., e-commerce shopping cart). After all applicable promotions and/or incentives have been applied, consumer may submit the order.

At step 708, the merchant validates the promotions and incentives. At step 709, the merchant system takes any necessary actions to data associated with the promotion and/or incentive (e.g., reduce total remaining counter by a number or other value). At step 710, a response is generated and displayed to the consumer in relation to the redemption request. In the case of a successful redemption, the consumer's purchasing channel may be updated and a message displayed to the consumer. In the case of a failure or an error, the consumer may be notified of such failure or error or some portion thereof. At step 711, the merchant system checks to see if there are any more promotions or incentives to validate.

Steps 707-711 are repeated until there are no more promotions or incentives to validate.

At step 712, a purchasing channel checkout process is provided to the consumer and the consumer completes a payment transaction with respect to the checkout. In an exemplary embodiment, the merchant system or some third-party system would provide transaction validation and any required security checks associated with such validation.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing real-time product loyalty marketing with various marketing channels in one or more multi-tier product loyalty campaigns, the system comprising:
an application server comprising a processor, computer-executable code stored in non-volatile memory and a communications means,
wherein said processor, said computer-executable code and said communications means are operably connected and are configured to:
configure a product loyalty program with multi-tier incentives;
receive one or more user registrations associated with said product loyalty program;
provide one or more loyalty incentives to at least one user based at least in part on purchases made using said product loyalty program;
receive a redemption request from said at least one user;
process said redemption request; and
distribute a reward to said at least one user based at least in part on said redemption request.

2. The system of claim 1, wherein said multi-tier incentives comprises at least one tier of group incentives.

3. The system of claim 1, wherein said multi-tier incentives comprises two or more tiers of group incentives with each successive group incentives tier being combinable with the former group incentive tiers.

4. The system of claim 1, wherein said multi-tier incentives comprises at least one tier of purchase incentive upgrades.

5. The system of claim 1, wherein said multi-tier incentives comprises two or more tiers of product incentive upgrades with each successive product incentive upgrade tier being combinable with the former product incentive upgrade tiers.

6. The system of claim 1, wherein said multi-tier incentives comprises at least one tier of referral incentives.

7. The system of claim 1, wherein said multi-tier incentives comprises two or more tiers of referral incentives with each successive referral incentive tier being combinable with the former referral incentive tiers.

8. The system of claim 1, wherein said multi-tier incentives comprises at least one group incentive tier, at least one product incentive upgrade tier and at least one referral incentive tier.

9. The system of claim 8, wherein utilization of two or more of said at least one group incentive tier, at least one product incentive upgrade tier and at least one referral incentive tier provides a combination incentive.

10. The system of claim 9, wherein said combination incentive provides an incentive that is independent of any other multi-tier incentive.

11. A method for providing real-time product loyalty marketing with various marketing channels in one or more multi-tier product loyalty campaigns, the method comprising:
configuring a product loyalty program with multi-tier incentives;
receiving one or more user registrations associated with said product loyalty program;
providing one or more loyalty incentives to at least one user based at least in part on purchases made using said product loyalty program;
receiving a redemption request from said at least one user;
processing said redemption request; and
distributing a reward to said at least one user based at least in part on said redemption request.

12. The method of claim 11, wherein said multi-tier incentives comprises at least one tier of group incentives.

13. The method of claim 11, wherein said multi-tier incentives comprises two or more tiers of group incentives with each successive group incentives tier being combinable with the former group incentive tiers.

14. The method of claim 11, wherein said multi-tier incentives comprises at least one tier of purchase incentive upgrades.

15. The method of claim 11, wherein said multi-tier incentives comprises two or more tiers of product incentive upgrades with each successive product incentive upgrade tier being combinable with the former product incentive upgrade tiers.

16. The method of claim 11, wherein said multi-tier incentives comprises at least one tier of referral incentives.

17. The method of claim 11, wherein said multi-tier incentives comprises two or more tiers of referral incentives with each successive referral incentive tier being combinable with the former referral incentive tiers.

18. The method of claim 11, wherein said multi-tier incentives comprises at least one group incentive tier, at least one product incentive upgrade tier and at least one referral incentive tier.

19. The method of claim 18, wherein utilization of two or more of said at least one group incentive tier, at least one product incentive upgrade tier and at least one referral incentive tier provides a combination incentive.

20. The method of claim 19, wherein said combination incentive provides an incentive that is independent of any other multi-tier incentive.
